(19) United States
(12) Patent Application Publication
(10) Pub. No.: US 2011/0143300 A1
(43) Pub. Date: Jun. 16, 2011

(54) DENTAL DEVICE FOR CORRECTING UPPER JAW TRANSVERSAL MICROGNATHISM IN ADULT PATIENTS AND PROCEDURE FOR BUILDING THE DEVICE AND A SURGICAL

(76) Inventor: Raul Horacio VILLAALBA, Cerro de las Rosas (AR)

(21) Appl. No.: 12/962,338

(22) Filed: Dec. 7, 2010

(30) Foreign Application Priority Data
Dec. 11, 2009 (AR) 20090104833

(51) Int. Cl. A61C 7/10; A61C 11/00; A61C 19/04

(52) U.S. Cl. 433/7; 29/896.11; 433/213

(57) ABSTRACT

A dental device for the correction of upper jaw transversal micrognathism in adult patients, which makes it possible to apply a slow expansion orthopedic technique, without osteotomy with osseo fixation by means of micro-implants, which comprises an expansion component, bilateral palatine support components, and a fixation component. The expansion component is an expansion screw joined to the palatine support components by means of lateral arms that extend out of it, where said palatine support components have perforations for receiving the fixation components defined by the micro-implants. The invention also provides a procedure for building the device and for setting up a surgical guide for said device.

### FIELD OF THE INVENTION

The present invention refers to a dental device for the correction of upper jaw transversal micrognathism in adult patients and a procedure to set up the device and a surgical guide, and, more particularly, a device which makes it possible to apply a slow expansion orthopedic technique without osteotomy with bone fixation through micro implants.

### STATE OF THE ART

Within the matter's prior art, the most popular appliance for correcting upper jaw transversal micrognathism is the “rapid palatal expander” (RPE). Expanding the median palatine suture is a method in which age is a fundamental factor for achieving the separation of the suture. As with the rest of the craniofacial sutures, the median palatal suture becomes increasingly tortuous and imbricated with age. After adolescence, there is a chance that periosteal bridges might have formed across the suture, partly obliterating it or making skeletal expansion impossible. As from the age of twenty, it is hard but not impossible to open the suture. Expansion is directed towards widening the upper jaw rather than expanding the dental arch or shifting the teeth with regard to the bone. The RPE increases lower jawbone transversal dimensions, correcting crossbite and increasing the length of the dental arch.

There are several types of banded expansion appliances, the Haas type and the Hyrax type of expanders, used both in children in mixed teething and in permanent teething during the period of growth. Spolyar describes several modifications to earlier types using miniscrews, springs, direct contact of the screw and the acrylic, covering occlusal surfaces of the middle and posterior sectors with a thermoplastic material to produce the orthopedic maxillary expansion. Lamparski and Davidoveich made modifications by anchoring the expander with two or four bands in some cases and noticed that it was possible to achieve results in small children with two bands and the effect is more anterior with two bands, while using four bands has a more posterior effect. In adults, these appliances bring about greater skeletal changes when expansion is assisted by surgery or by osteogenic distraction.

There are studies that claim that RPE separates the median palatal suture asymmetrically and that the greatest resistance occurs in the posterior region, with a greater V-shaped opening in the anterior region, so that the expansion appliance had to be placed near the region of anatomical resistance. This lateral rotation of the palatal halves, viewed in a front cross-section, increases nasal width and subsequent nasomaxillary remodeling. Expansion of the median palatal suture is frequently a key object in dentofacial orthopedic treatment. Sutures and periodontal ligaments (PL) are considered to have similar bone adaptation mechanisms.

One of the most important challenges the orthodontist comes up against in his or her daily clinical activity is that of controlling undesired reciprocal forces by means of “anchoring” the teeth subject to them. Traditionally, anchoring is a decision the orthodontist makes on the basis of the diagnosis during the initial phases of treatment, as well as during the whole therapeutic process; it is a key factor in determining the excellence of the orthodontist's work. The main sources of anchorage that orthodontists have used are natural or physiological anchorage, and therapeutic one, which have been widely described by different authors. These are variable according to dental brace techniques, removable or orthopedic applying light or heavy forces, which may be intra or extraoral, depending on what is indicated on the one hand, and of the dental support available on the other.

In order to overcome all of these limitations, conventional implants began to be used in the early 1990s as an anchoring system, taking advantage of the implant's huge resistance to movement which involves the phenomenon of osseointegration. Endosseous implants may serve as anchorage for orthodontic movement, including movement of the craniofacial complex, though they require bone to be available and to be placed in a region with no presence of vital structure, teeth, lower dental nerve, nasal or sinus cavities, anterior palatal nerve, posterior palatal nerve, also bearing in mind the thickness of soft tissue which may prevent or hinder the use of endosseus implants as orthodontic anchorage.

Small implants, or micro-implants, can be used as anchorage, regardless of the orthodontic technique employed, to develop movements of intrusion, extrusion, distalization, as anchorage for traction of included teeth, as a palatal fixation element of the pendulum, or in cases of agenesis, in conventional or surgically-assisted expansion, osteogenic distraction, in lingual orthodontics, and for intermaxillary fixation in surgical patients.

Among the slow maxillary expansion screws available on the market there are Italian ones like the Spider Screw, the German Micro Plus Titanium Plating System, and the South Korean Absor-Anchor. The Spider Screw is a self-drilling miniscrew that comes in three lengths: 7.9 and 11 mm with a diameter of 2.0 to 1.5 mm and three head designs: a) regular, b) low profile, c) flat low profile. The Abso-Anchor lengths are 4 to 11 mm and heads: a) flat, b) circular, c) bracket type.

Expansion of the median palatal suture is frequently a key object in dentofacial orthopedic treatment. Literature of different researchers reports that the increase in the width of the maxillary arch caused by orthopedic forces using dental support produces some type of movement (inclination) of the back teeth causing periodontal and dental damage. In our results, it was proved that any change in angulation of the dental elements was minimum, with no incidence in transversal increase, and producing no damage at the dental or periodontal levels, since the dental brace proposed is based on mucosa, with bone anchorage, and no participation of dental elements.

A variety of authors claim that if the forces applied are sufficiently great to make the suture give, maxillary separation may occur. Our study proved that using orthopedic forces achieves a separation of the median palatal suture in 70% of cases. Lineal and angular asymmetrical expansion has been put down to a variation in the rigidity of the circummaxillary articulations.

Even though there are descriptions in the literature of the effect of mechanical forces on craniofacial sutures, proven by means of cephalometric changes in the craniofacial morphology by the use of controlled forces generated by different types of extraoral anchorages and appliances for palatal expansion, these are different in degree, and contradictory findings have been described regarding long term stability.

Our research reasserts the concept expressed by Roberts (2006) where facial sutures are important mediators of skeletal adaptation to craniofacial growth and to biomechanical therapy, since alterations were also produced in regions distant from where the forces were applied. In tests conducted in patients of 14 to 27 years of age, whose full CT presented synostosis of the median palatal suture before treatment, it was shown that age was not a determining factor for expansion to occur with the technique proposed. On the other hand, it did influence the duration of treatment in that the older the patient, the greater the time needed for the effective activation period.

Because of necrosis occurring after expansion of a suture, osteogenic activity begins after scarring has taken place to reestablish the suture's vitality in the same way for PL as for other skeletal locations. The expansion of the suture brings about a regional acceleration of the bone's adaptive activity, which allows for broad adaptation of the bones involved in the new biomechanical conditions (Roberts 2006, Mc Namara 2006, Gandini 2000). This shows that the expansion of the suture within physiological limits is a clinically viable method for relocating bones in the craniofacial complex with the aim of enhancing aesthetics and function and is similar to osteogenesis by surgically mediated distraction (Parr 1997, Chang 1997, Enlow 1982-1999).

Our trials confirm different researchers' results in the regard that it is viable to relocate bones in the craniofacial complex without the need for surgical distraction, nor osteotomy, shown by CT. For this reason, and despite the diversity of technology available for acquiring images, the types and references for studies, it has been adopted in an attempt to balance the costs and benefits for the patient.

Our research assessed the effect of dental braces in occlusal and transversal cuts, of the nasomaxillary process, at the level of the alveolar ridge of the cortical alveoli at the cervical level, of the maxillary sinus and nostrils, the difference between pre and post treatment being statistically significant in all measurement fields, which confirms our hypothesis with regard to proving that the effect of widening the upper jaw was the result of its transversal skeletal increase by means of orthopedic modification achieved by opening and widening the median palatal suture and by modeling and remodeling the bone, detracting from the idea that the increase in the transversal distance of the upper jaw results from angulation of dental elements. This confirmed, based on the results of our study, in which the variables that measured the changes in angulation of dental elements and alveolar ridges, they were not statistically significant except for T1C, which measures the value of the dental inclination medians of the first molar on the right, whose difference was 3.32 degrees greater at the end of the treatment, and T3C which measures the value of the inclination medians of the right vestibular cortical, whose difference was 1.85 degrees greater by the end of the treatment. The results show that in adults it is possible to achieve significant changes in widening the upper jaw by applying orthopedic forces. These results were confirmed by measurements made in studying the upper jaw model in each patient before and after treatment, where the increase of the different perimeters of the dental arch, of the transversal distances at the dental level, and at the level of the alveolar ridges, in the transversal direction, it was statistically significant in each and all of the values in the study, with the antecedent of the methodology used by Stevens (2006) and Hussain (2008).

On the other hand, it must be considered that these significant outcomes are the result of applying dental braces, which differ biomechanically from those applied conventionally, generally during growth and, when compared to them, clearly show the advantages of the method used in our research, in that it does not produce gingival dehiscence, root resorption, excessive dental inclination, fracture of alveolar tables, as well as not requiring invasive surgical techniques.

There are several types of banded expansion braces, the Haas type and the Hyrax type of expanders, used both in children in mixed teething and in early permanent teething. Spolyar (1984) describes several modifications to earlier types using miniscrews, springs, direct contact of the screw and the acrylic, covering occlusal surfaces of the middle and posterior sectors with a thermoplastic material to produce orthopedic maxillary expansion. In 1995 Mc Namara began doing direct adhesion MRE in mixed and early permanent teething, a method that showed some advantages, such as not causing inclination in molars and increasing the perimeter of the arch, increasing the volume of the nasal cavity; as well as this, it attempted to avoid gingival recessions in alveolar regions and root resorption in some regions of the anchor teeth that may occur with band anchored appliances. Lamparski in 2003 and Davidoveich in 2005 made modifications by anchoring the expander with two or four bands in some cases and noticed that it was possible to obtain the desired effects in small children with two bands and in the anterior region, than with four bands which affects the posterior region. In 1996 Bonetti applied a disconnectible palatal expander. The methods used by the authors mentioned above, along with their modifications and adaptations, were used in patients in growth, so they are not applicable to this study.

There are studies that claim that RPE separates the median palatal suture asymmetrically and that the greatest resistance occurs in the posterior region, with a greater V-shaped opening in the anterior region, so the expansion apparatus had to be placed near the region of anatomical resistance. Even though widening of the upper jaw occurred in all cases in our trials, this widening of the posterior sector was greater, in millimeters, than in the anterior sector, which does not coincide with the studies of the previous authors and does coincide with those of Matteini y Mommaerts in 2001, who defended this hypothesis when they informed the results of the palatal expansion performed after a surgical distraction of the posterior articulations of the palate to produce pterygomaxillary expansion and achieve parallel expansion.

In a front view of the jawbone, Bell (1982) showed a lateral rotation with inclination of the lateral palatine processes. The movement of the median palatine parts is greater in the alveolar crests and less in the palatine depth, presenting a triangular expansion based on the incisors whose apex is in the nasal region, and an occlusal view where it could be seen that a greater aperture of the palatine suture had occurred in the anterior region gradually diminishing towards the posterior region. Bell and Epker, while performing a distraction and/or surgical treatment, researched the influence of morphology and skeletal maturity of the median palatine and pterygomaxillary suture on expansion in adults with bilateral horizontal deficiency, and considered that the increase in skeletal maturity might be the key to considering palatine osteotomy. Surgeons state that the effect of expansion appliances on adults without maxillary osteotomy may be iatrogenic due to greater root resorption, compression of the periodontal ligament and the possibility of relapse.

Our research detracts from claims mentioned earlier, since the integrity of the dental element, periodontal ligament and alveolar bone remained unaltered, as did the palatine mucosa. The greatest consequence is due to the adult's greater degree of resistance in the median palatal and circummaxillary sutures.

The different screws and miniscrews available are producing excellent clinical results. They are easy to place and remove and rarely result in complications. They can be placed in the palate, the alveolar bone, the apical bone and even between the mesial and distal roots of a molar. For our technique, these advantages were used on account of the need to place the anchorages in the anterior and posterior sectors of the palatine and upper jaw region. Length was selected on the basis of mucosa thickness and location, as well as penetration angle in relation to bone surface. Added to these variables was the thickness of the lateral supports of the proposed appliances. In addition, parameters of some researchers were followed, where the screws do not osseo-integrate, they are screwed in and in the opinion of some authors they must be loaded immediately, so the dental braces were activated immediately. No loss of implants was observed for this reason and the time the dental braces remained in the mouth shortened considerably, which would have been different if conventional or juxta-osseos implants had been used.

### SUMMARY OF THE INVENTION

The aim of the present invention is to make a dental device available for the correction of upper jaw transversal micrognathism in adult patients that will make it possible to apply a slow orthopedic expansion technique without osteotomy with osseo fixation by means of micro-implants. It comprises an expansion component, bilateral palatine support components, and one fixation component, where the expansion component is a screw joined to the palatine support components by means of lateral arms that reach out from it, each of which have perforations for the reception of the fixation components defined by the micro-implants.

In addition, the aim of the present invention is to make procedures available for building a device and for setting up a surgical guide for the device.

### BRIEF DESCRIPTION OF THE DRAWINGS

For greater clarity and understanding of the object of the present invention, it has been illustrated in various figures which depict it, as examples, according to preferred forms of realization where:

FIG. 1 is a perspective view of the expansion screw used in the device used in the present invention.

FIG. 2 is a front view that depicts the expansion screw in FIG. 1 connected to part of the bilateral palatine support components and the fixation components laid out on the model of an upper jaw.

FIG. 3 is a front view that depicts the complete device laid out on the model of an upper jaw.

### DETAILED DESCRIPTION OF THE INVENTION

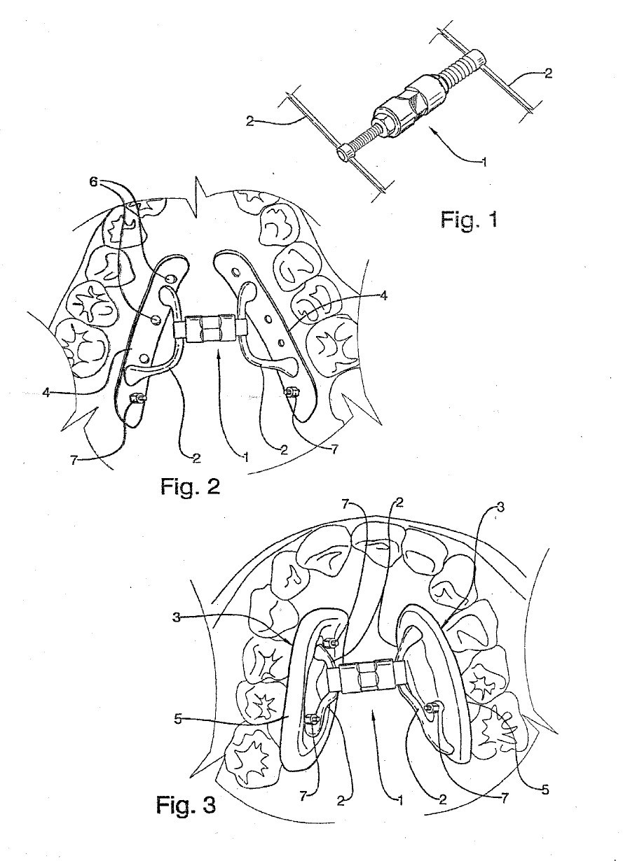

FIG. 1 shows the expansion component used in this dental device for correcting upper jaw transversal micrognathism in adult patients. It is defined by one expansion screw 1, in particular an expansion screw with a hexagonal body and thread and counter-thread extensions of 12+12 mm aperture or 16+18 mm aperture, depending on what is appropriate in each case in which it is applied, on the ends of which the corresponding lateral arms 2 are mounted. This expansion device was chosen because for every 360° it is turned, it achieves a transversal widening effect of 1 mm. The fact that the central activation part of the expansion screw 1 body is hexagonal, makes it possible to activate the dental braces slowly, introducing the principle of friction into its structure, thus avoiding loss of expansion, though on a small scale, given by unscrewing as a result of lower bone resistance. Since the expansion screw 1 is made up of a triple telescopic mechanism, it does not transmit the activation rotation movement to the lateral components (illustrated in FIGS. 2 and 3), ensuring only transference of the transversal force to the lower bones and dentures. It has a scale graded every 2 millimetres on one of its moving parts, which ensures safe activation control.

FIGS. 2 and 3 show the device as including bilateral palatine support components 3 that are made up of stainless steel sheets 4 with acrylic coverings 5 for self-curing acrylic prosthetic filling, with a separation of 0.5 to 1 mm from the palate; each sheet 4 is fully covered and extends to its palatal side. These sheets 4 are, for example, 0.5 mm thick, between 4 and 5 mm wide and 20 mm long. In practice this length is determined by each particular patient's needs.

Each bilateral palatine support component 3 presents, for example, two, three or four perforations 6 for receiving the fixation components defined by the micro-implants 7. These perforations 6 for receiving the micro-implants 7 are variable in diameter, for example, between 1.1 and 1.4 mm. The micro-implants 7 have conical trunks with circular heads, a perimeter of 2.28 to 3.05 mm (0.09 to 0.12 inch) and are 8 to 12 mm long, preferably those marketed under the trademark Abso-Anchor, and preferably four micro-implants are used per jaw.

The palatine support components 3 are joined to the expanding screw 1 by means of the lateral arms 2 which extend out from it in curves. The lateral arms 2 are joined to the stainless steel sheets 4 by means of laser or silver soldering and determine extreme fixation and invariable position, both in width as in front to back and depth.

The procedure for fixing the device described above is as follows:

Perform a double cast of the upper jaw and proceed to do a filling of the impressions twice.

Set up lateral supports using 0.6 mm thick, 5 mm wide and 20 mm long stainless steel sheets, adapted to the palatine processes on either side, in such a way that the lateral supports are separated from the mucosa by about 1.2 mm with heat resistant adhesive putty after rounding the vertices of the lateral supports;

Bend the lateral arms that reach out from the expansion screw in the direction of the palatal faces of the hard palate, adapting them to the previously made stainless steel lateral supports;

Once the lateral arms have adapted completely, solder them to the lateral supports using laser or silver soldering;

Set up the definite support of the metallic structure to the palatine mucosa in such a way that the metal does not come into contact with the palatine mucosa by using a plastic state acrylic filling on either side of the hard palate, from canines to second molars, where the filling thickness is approximately 0.5 mm;

Place the metallic structure directly over the acrylic in the appropriate position and press until there is a thickness of between 0.1 and 0.2 mm below the stainless steel sheets of the palatine supports;

Cover the metallic structure with acrylic and adapt the final margins to it;

Polymerize the structure by means of a “Dentarium”, or similar, polymerizer for 40 minutes in water at 36° C. and a pressure of 3 atmospheres; and

Remove the appliance from the model for finishing, removing excess acrylic, giving the appliance a high speed finish with a tungsten carbide burr, then with metal wearing rubber for the finishing on the metal part, followed by sandpaper mounted on a mandrel for the acrylic portion of the expansion screw, and complete the finishing with a high-shine felt cone.

The procedure for setting up the surgical guide for the device of the present invention comprises the following steps:

Place a 2 mm-thick sheet of PETG (Polyethylene Terephthalate Glycol) for plate thermoforming by stamping on the work model with the intraoral dental brace ready made and placed in perfect adaptation so that the final position in the mouth is represented;

Extract the surgical guide with the expander from the model to examine excesses on the edges and monitor adaptation of the expander to the guide, making sure it allows for the appropriate separation between them in order to facilitate its removal at the end of surgery;

Determine the location of the micro-implant entry;

Make the orifices for the micro-implant entries through the surgical guide and the expander with the necessary direction, angulation and depth; and

Make the relief apertures in the surgical guide to allow it to be removed from the mouth once the micro-implants have been placed.

The aim of this guide was to be able to work safely, in order to avoid any positional change of the dental braces within the mouth during the different surgical phases.

1. A dental device available for the correction of upper jaw transversal micrognathism in adult patients that will make it possible to apply a slow orthopaedic expansion technique without osteotomy with osseo fixation by means of micro-implants, the dental device comprising:
an expansion component,
bilateral palatine support components, and
one fixation component,
wherein the expansion component is a screw joined to the components palatine support components by means of lateral arms that reach out from it, each of which have perforations for the reception of the fixation components defined by the micro-implants.

2. The dental device according to claim 1, wherein said expansion screw is hexagonal with thread and counter-thread, approximately 12+12 mm in aperture.

3. The dental device according to claim 1, wherein said expansion screw is hexagonal with thread and counter-thread, approximately 16+18 mm in aperture.

4. The dental device according to claim 1, wherein said palatine support components are made up of stainless steel sheets covered in acrylic for prosthetic self-curing filling.

5. The dental device according to claim 4, wherein said stainless steel sheets have a thickness of at least 0.5 mm, a width of approximately 4 mm and 5 mm, and a length specifically determined on the basis of the length of the support for each particular patient.

6. The dental device according to claim 4, wherein the lateral arms are joined to the stainless steel sheets 4 by means of laser or silver soldering and determine extreme fixation and invariable position, both in width as in front to back and depth.

7. The dental device according to claim 6, wherein said soldering is laser soldering.

8. The dental device according to claim 6, wherein said soldering is silver soldering.

9. The dental device according to claim 1, wherein said lateral arms extend out from the expansion screw and said palatine components do so in a curved manner.

10. The dental device according to claim 1, wherein said perforations receiving micro-implants have a diameter of between approximately 1.1 mm and 1.4 mm.

11. The dental device according to claim 1, wherein said palatine components present at least two perforations receiving micro-implants.

12. The dental device according to claim 1, wherein said micro-implants have conical trunks and circular heads.

13. The dental device recited in claim 12, wherein said micro-implants have a perimeter of 2.28 mm to 3.048 mm (0.09 to 0.12 inches) and approximately 8 to 13 mm in length.

14. A method for building the device according to claim 1 comprising the steps of;
a) performing a double cast of the upper jaw and proceed to do a filling of the impressions twice;
b) setting up the lateral supports using stainless steel sheets adapted to both sides of the palatine processes;
c) bending the lateral arms that reach out from the expansion screw in the direction of the palatal faces of the hard palate, adapting them to the previously made stainless steel lateral supports;
d) after the lateral arms have been completely adapted, soldering the lateral arms to the lateral supports using soldering selected between laser or silver soldering;
e) setting up the definite support of the metallic structure to the palatine mucosa in such a way that the metal does not come into contact with the palatine mucosa by using a plastic state acrylic filling on either side of the hard palate, from canines to second molars;
f) placing the metallic structure directly over the acrylic in the appropriate position and press until there is a thickness of between approximately 0.1 and 0.2 mm below the stainless steel sheets of the palatine supports;
g) covering the metallic structure with acrylic and adapt the final margins to it;
h) polymerizing the structure with a polymerizer for 40 minutes in water at 36° C. and a pressure of 3 atmospheres; and
i) removing the dental braces from the model for finishing by eliminating excess acrylic.

15. The according to claim 14, wherein said stainless steel sheets are in the area of 0.6 mm thick, 5 mm wide and 20 mm long approximately.

16. The method according to claim 14, wherein said stainless steel lateral supports are separated from the mucosa by approximately 1.2 mm by means of a heat resistant adhesive putty, after having rounded the vertices of said lateral supports.

17. The method according to claim 14, wherein said acrylic filling has a thickness of approximately 0.5 mm.

18. The method according to claim 14, wherein the finishing of the appliance is performed at high speed with a tungsten carbide milling cutter, then with metal wearing rubber for the finishing on the metal part, followed by sandpaper mounted on a mandrel for the acrylic portion of the expansion screw, and complete the finishing with a high-shine felt cone.

19. A method for setting up the surgical guide for the device according to in claim 1, comprising the steps of:
a) placing a 2 mm-thick sheet of PETG for plate thermoforming by stamping on the work model with the dental braces placed and perfectly adapted;
b) extracting the surgical guide with the expander from the model to examine excess on the edges and monitor adaptation of the expander to the guide, making sure it allows for the appropriate separation between them in order to facilitate its removal at the end of surgery;
c) determining the location of the micro-implant entry;
d) making the orifices for the micro-implant entries through the surgical guide and the expander with the necessary direction, angulation and depth; and
e) making the relief apertures in the surgical guide to allow it to be removed from the mouth once the micro-implants have been placed.
